(19) United States
(12) Patent Application Publication
(10) Pub. No.: US 2026/0028476 A1
(43) Pub. Date: Jan. 29, 2026

(54) POLYETHYLENE BLEND FOR CAPS AND CLOSURES

(71) Applicant: Equistar Chemicals, LP, Houston, TX (US)

(72) Inventors: Sameer D. Mehta, Mason, OH (US); Michael Camara, Cincinnati, OH (US); Harilaos Mavridis, Lebanon, OH (US)

(73) Assignee: Equistar Chemicals, LP, Houston, TX (US)

(21) Appl. No.: 19/277,674

(22) Filed: Jul. 23, 2025

Related U.S. Application Data
(60) Provisional application No. 63/675,060, filed on Jul. 24, 2024.

(51) Int. Cl. C08L 23/08

(52) U.S. Cl. CPC C08L 23/08; C08L 2205/025; C08L 2207/062

(57) ABSTRACT

Compositions that blend a first polyethylene (PE) component that is one or more high density PE and a second polyethylene component are provided. The blends demonstrate improved ESCR performance and stiffness relative to currently available caps and closures used in carbonated soft drinks products. The blend also has a suitable die swell for compression molding.

### PRIOR RELATED APPLICATION

This application claims the benefit of priority to U.S. Provisional Application No. 63/675,060, filed on Jul. 24, 2024, which is incorporated here by reference in its entirety.

### FIELD OF THE INVENTION

The present disclosure relates to blends of a high density polyethylene and a second polyethylene for use in caps and closures.

### BACKGROUND OF THE INVENTION

Polyolefins, in particular polyethylene (PE), is increasingly consumed in large amounts for many applications, including packaging for food and other goods, electronics, automotive components, and a great variety of manufactured articles. Applications for use of high density polyethylene (HDPE) resins commonly include, but are not limited to, small blow-molding, caps and closures, jerry cans, high molecular weight films, injection molding, conduit, industrial bulk containers, and the like.

Of particular interest is caps and closure applications in view on an increasing “on-the-go” lifestyle. This trend has led to smaller, more convenient packaging that must balance easy to open qualities, resealability, and cost effectiveness. With increasing demand for convenience packaging and growing concerns about product safety and security, much emphasis is placed on caps and closures that are lighter while having the same or better environmental stress cracking resistance (ESCR), impact strength, and stiffness. However, care must be taken to not worsen processability of the resin or blends or packaging efficiency of the cap and closure.

It would be desirable to develop compositions used for caps and closures that have good environmental stress cracking resistance, impact strength, and stiffness without sacrificing processability and user-friendly features.

### SUMMARY OF THE INVENTION

In general, the present disclosure relates to compositions comprising a blend of a first PE component and a second PE component. The first PE component is a high density PE and the second PE component may be a low density PE (LDPE), a linear low density PE (LLDPE), a medium density PE (MDPE) or a HDPE.

In some embodiments, the first PE component is present in the blend in an amount in the range of from 60 wt. % to 90 wt. %, and the second PE component is present in the blend in an amount in the range of from 10 wt. % to 40 wt. %, wherein weight percentages are based on the total weight of first PE component and the second PE component.

In some embodiments, the first PE component has a density in the range of from 0.940 g/cm³ to 0.970 g/cm³, a melt index (MI₂) in the range of from 0.1 g/10 min to 1.0 g/10 min, an environmental stress crack resistance (“ESCR”) F10 in the range of from at least 4 hours to greater than 1000 hours in 100% Igepal, and a flexural modulus of 100,000 psi (˜689 MPa) to 220,000 psi (˜1,516 MPa) by the 2% secant method (“2% flexural modulus”). In other embodiments, the first PE component has a C4-C8 comonomer present in an amount of greater than 0 wt. % and less than 10 wt. %. In yet other embodiments, the first PE component is an HDPE typically used for conduit or small blow molded articles.

In some embodiments, the second PE component has a density in the range of from 0.910 g/cm³ to 0.970 g/cm³, a melt index (MI) in the range of from 5 g/10 min to 35 g/10 min, an environmental stress crack resistance (“ESCR”) F10 in the range from less than 10 hours to greater than to 1,000 hours in 100% Igepal, and a flexural modulus of 20,000 psi (˜137 MPa) to 220,000 psi (˜1,516 MPa) by the 2% secant method. In other embodiments, the second PE component is a homopolymer or a copolymer that has a C4-C8 comonomer present in an amount of greater than 0 wt. % and less than 30 wt. %. In yet other embodiments, the second PE component is an injection PE resin.

In some embodiments, the blend has a density in the range of from 0.935 g/cm³ to 0.958 g/cm³, a melt index (MI₂) in the range of from 0.20 g/10 min to 2.0 g/10 min, and an environmental stress crack resistance (“ESCR”) F10 in the range of from at least 4 hours to greater than 1,000 hours in 100% Igepal. In other embodiments, the blend has one or more of the following: (1) a 2% flexural modulus of at least 120,000 psi (˜827 MPa) or between 135,000 and 155,000; (2) a die swell greater than 145% or between 180% and 210%; (3) a PDR between 15 and 40 or between 20 and 25, (4) an ER between 3.70 and 4.1 or between 3.7 and 3.9, or (5) a HLMI in the range of 40 g/10 min to 80 g/10 min.

In some embodiments, the composition is produced by melt blending the first and second PE components, and optionally one or more additives including primary and/or secondary antioxidants, slip agents and UV stabilizers, to form a pelletized product. In some embodiments, the first and second PE components are virgin or recycled PE, or combinations thereof.

The foregoing has outlined rather broadly the features and technical advantages of the present invention in order that the detailed description of the invention that follows may be better understood. Additional features and advantages of the invention will be described hereinafter, which form the subject matter of the claims of the invention. It should be appreciated by those skilled in the art that the conception and specific embodiments disclosed may be readily utilized as a basis for modifying or designing other film structures and/or processes for carrying out the same purposes of the present invention. It should also be realized by those skilled in the art that such equivalent constructions do not depart from the spirit and scope of the invention as set forth in the appended claims. The novel features which are believed to be characteristic of the invention, both as to its structure and method of manufacture, together with further objects and advantages will be better understood from the following description.

### DETAILED DESCRIPTION OF THE INVENTION

Illustrative embodiments of the subject matter claimed below will now be disclosed. In the interest of clarity, some features of some actual implementations may not be described in this specification. It will be appreciated that in the development of any such actual embodiments, numerous implementation-specific decisions must be made to achieve the developer's specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than the broadest meaning understood by skilled artisans, such a special or clarifying definition will be expressly set forth in the specification in a definitional manner that provides the special or clarifying definition for the term or phrase. It must also be noted that, as used in the specification and the appended claims, the singular forms “a,” “an,” and “the” include plural references unless otherwise specified.

For example, the following discussion contains a non-exhaustive list of definitions of several specific terms used in this disclosure (other terms may be defined or clarified in a definitional manner elsewhere herein). These definitions are intended to clarify the meanings of the terms used herein. It is believed that the terms are used in a manner consistent with their ordinary meaning, but the definitions are nonetheless specified here for clarity.

### Definitions

“Antioxidant agents,” as used herein, means compounds that inhibit oxidation, a chemical reaction that can produce free radicals and chain reactions. Antioxidants are differentiated based on their reaction mechanisms and include: (1) primary antioxidants, and (2) secondary antioxidants.

“Compounding conditions,” as used herein, means temperature, pressure, and shear force conditions implemented in an extruder to provide intimate mixing of two or more polymers and optionally additives to produce a substantially homogeneous polymer product.

“HDPE,” as used herein, means ethylene homopolymers and ethylene copolymers having a density in the range of 0.940 g/cm³ to 0.970 g/cm³ and produced in a gas phase, slurry phase and/or solution phase polymerization using known equipment and reaction conditions. Catalyst used to produce the HDPE can include chromium-based catalyst and Ziegler-Natta (ZN) catalyst.

In some embodiments, polymerization temperatures range from about 0° C. to about 300° C. at atmospheric, subatmospheric, or superatmospheric pressures.

Slurry or solution polymerization systems can utilize subatmospheric or superatmospheric pressures and temperatures in the range of about 40° C. to about 300° C. An exemplary liquid phase polymerization system is described in U.S. Pat. No. 3,324,095, the disclosure of which is fully incorporated by reference herein. Liquid phase polymerization systems generally comprise a reactor to which olefin monomer and catalyst composition are added, and which contains a liquid reaction medium for dissolving or suspending the polyolefin. The liquid reaction medium may consist of the bulk liquid monomer or an inert liquid hydrocarbon that is nonreactive under the polymerization conditions employed. Although such an inert liquid hydrocarbon need not function as a solvent for the catalyst composition or the polymer obtained by the process, it usually serves as solvent for the monomers employed in the polymerization. Among the inert liquid hydrocarbons suitable for this purpose are isopentane, hexane, cyclohexane, heptane, benzene, toluene, and the like. Reactive contact between the olefin monomer and the catalyst composition should be maintained by constant stirring or agitation. The reaction medium containing the olefin polymer product and unreacted olefin monomer is withdrawn from the reactor continuously. The olefin polymer product is separated, and the unreacted olefin monomer and liquid reaction medium are recycled into the reactor.

Gas phase polymerization systems can utilize superatmospheric pressures in the range of from 1 psig (6.9 kPag) to 1,000 psig (6.9 MPag), 50 psig (344 kPag) to 400 psig (2.8 MPag), or 100 psig (689 kPag) to 300 psig (2.1 MPag), and temperatures in the range of from 30° C. to 130° C. or 65° C. to 110° C. Gas phase polymerization systems can be stirred or fluidized bed systems. In some embodiments, a gas phase, fluidized bed process is conducted by passing a stream containing one or more olefin monomers continuously through a fluidized bed reactor under reaction conditions and in the presence of catalyst composition at a velocity sufficient to maintain a bed of solid particles in a suspended condition. A stream containing unreacted monomer is withdrawn from the reactor continuously, compressed, cooled, optionally partially or fully condensed, and recycled into the reactor. Product is withdrawn from the reactor and make-up monomer is added to the recycle stream. As desired for temperature control of the polymerization system, any gas inert to the catalyst composition and reactants may also be present in the gas stream.

“LDPE,” as used herein, means ethylene copolymers produced in a high pressure, free radical polymerization process and having a density in the range of 0.915 g/cm³ to 0.930 g/cm³.

“LLDPE,” as used herein, means ethylene copolymers produced in a low pressure polymerization process and having a density in the range of 0.915 g/cm³ to 0.930 g/cm³.

The HDPE, LDPE, and/or LLDPE described herein comprise homopolymers and/or copolymers of units derived from ethylene and units derived from one or more of C₃-C₁₂ α-olefins. Such C₃-C₁₂ α-olefins include, but are not limited to, substituted or unsubstituted C₃ to C₁₂ alpha olefins such as propylene, butene, pentene, hexene, heptene, octene, nonene, decene, undecene, dodecane, and isomers thereof.

“Recycled PE,” as used herein, means post-consumer recycled (“PCR”) PE and/or post-industrial recycled (“PIR”) PE. Recycled PE is derived from an end product that has completed its life cycle as a consumer item and would otherwise be disposed of as waste (e.g., a polyethylene water bottle) or from plastic scrap that is generated as waste from an industrial process. Post-consumer polyolefins include polyolefins that have been collected in commercial and residential recycling programs, including flexible packaging (cast film, blown film and BOPP film), rigid packaging, blow molded bottles, and injection molded containers. Usually, through a step of separation from other polymers, such as nylon, polyamides, PVC, PET or PS, two main polyolefinic fractions are obtained, namely PE recyclate (including HDPE, MDPE, LDPE, and LLDPE) and polypropylene recyclate (including homopolymers, random copolymers, and heterophasic copolymers). Polyethylene recyclate, also referred to herein as recycled PE, can be further separated to recover a portion having a PE as the primary constituent.

“Primary antioxidants,” as used herein, means compounds which function essentially as free radical terminators or scavengers. Primary antioxidants react rapidly with peroxy and alkoxy radicals. The majority of primary antioxidants for polymers are sterically hindered phenols.

“Processability,” as used herein, refers to how well a polymer composition can be formed into a cast of blown film of commercial quality or molded by injection or compression molding into a molded article of commercial quality at commercially acceptable rates using the equipment and conditions.

“Secondary antioxidants,” as used herein, means compounds which are preventive antioxidants that function by retarding chain initiation. Secondary antioxidants react with hydroperoxides to yield non-radical products and are, therefore, frequently called hydroperoxide decomposers.

“Virgin PE,” as used herein, are pre-consumer PEs. Pre-consumer PEs are products obtained directly or indirectly from petrochemical feedstocks fed to a polymerization apparatus. Pre-consumer polyolefins can be subjected to post polymerization processes such as, but not limited to, extrusion, pelletization, peroxidation, visbreaking, and/or other processing completed before the product reaches the end-use consumer. In some embodiments, virgin polyolefins have a single heat history. In some embodiments, virgin polyolefins have more than one heat history. In some embodiments, virgin polyolefins comprise no additives. In some embodiments, virgin polyolefins comprise additives.

Caps and closures used in carbonated soft drinks (CSD) or other beverage applications are generally produced via injection or compression molding. Injection molding generally requires resins with a higher melt index (MI) and imparts more residual stresses into the final part. Injection molding has been the dominant molding technique of caps and closures in Canada and Europe. As a result of the higher residual stresses, resins used for CSD require excellent ESCR and density balance to meet the crack resistance and stiffness requirements for the application. Previous generations of these resins were HDPE copolymers with an MI and density ranging from 2-3 g/10 min and 0.950-0.956 g/cm³, respectively. As caps have continually downgauged to meet recent lifestyle trends, higher performance resins have been developed to increase the ESCR performance at the same density. This has led to the MI of the resins to be driven lower to 1-2 g/10 min and made to be bimodal HDPE. As a result of the steep requirements of this application, there are fewer suppliers available. This has led to higher pricing and less availability of suppliers for these resins.

In the US market, caps and closures for CSD are generally produced by compression molding. Due to the lower operating temperature and melt pressure of the extrusion process compared to injection molding, the final part has much lower residual stress and resins with lower MI can be utilized (0.3-2 g/10 min).

It is believed that the lower residual stress allows for resins with lower ESCR to be used in the application. Because of the robustness of the compression molding process in terms of MI, it is believed that chrome based resins could be used in place of the bimodal HDPE CSD resins even though their ESCR is generally lower. As there are several chrome resin suppliers in the market, this may also allow for lower costs for the convertor compared to purchasing bimodal HDPE CSD resins. Additionally, it is believed that, if there is a desire to increase the MI of the chrome resin used in the compression process, a higher MI resin can be added to improve processability without affecting processability or ESCR very much. If a high ESCR resin is used as the majority component, the MI can be raised without reducing the ESCR of the cap too much.

### PE Blend Compositions

Disclosed herein are compositions comprising a blend of a first PE blend component and a second PE blend component, wherein the first PE component is a high density PE and the second PE component is a low density PE (LDPE), a linear low density PE (LLDPE), a medium density PE (MDPE) or a HDPE.

In some embodiments, the PE blend is a combination of at least two HDPEs, an HDPE and an LLDPE, an HDPE and an LDPE, and/or an HDPE and a MDPE.

In some embodiments, the first PE component is present in the blend amount in the range of from 60 wt. % to 90 wt. %, from 70 wt. % to 85 wt. %, from 75 wt. % to 80 wt. %. Correspondingly, the second PE component is present in the blend amount in the range of from 10 wt. % to 40 wt. %, from 20 wt. % to 30 wt. %, from 20 wt. % to 25 wt. %. All weight percentages are based on the total weight of the first PE component and the second PE component.

In some embodiments, the blend composition has one of more of:
a) a density in the range of from 0.935 g/cm³ to 0.958 g/cm³;
b) a melt index (MI₂) in the range of from 0.20 g/10 min to 2.0 g/10 min;
c) an environmental stress crack resistance (“ESCR”) F50 in the range of from at least 4 hours to greater than 1,000 hours in 100% Igepal; and,
d) an environmental stress crack resistance (“ESCR”) F10 in the range of from at least 4 hours to greater than 1,000 hours in 100% Igepal or in the range of from 48 hours to 130 hours in 100% Igepal.

In some embodiments, the blend composition has one of more of:
a) a number average molecular weight (Mₙ) in the range of from 8,000 g/mol to 20,000 g/mol or in the range of from 10,000 g/mol to 13,000 g/mol;
b) a weight average molecular weight (M_{w}) in the range of from 80,000 g/mol to 200,000 g/mol or from 90,000 g/mol to 160,000 g/mol;
c) a molecular weight distribution (MWD) in the range of from 5 to 20 or from 8 to 15;
d) a high load melt index (HLMI) in the range of from 30 g/10 min to 100 g/10 min or from 50 g/10 min to 80 g/10 min or from 55 g/10 min to 75 g/10 min; and
e) a 2% flexural modulus in the range of from 120,000 psi (827 MPa) to 160,000 psi (1,103 MPa) or from 135,000 psi (930 MPa) to 150,000 psi (1,034 MPa).

In some embodiments, the blend composition has one of more of:
a) a melt index ratio (MIRA) in the range of from 60 to 90; and/or
b) a zero shear viscosity (ETA0 or η₀) in the range of from 1.4×10⁶ to 4.0×10⁶.

In some embodiments, the first PE component and the second PE component are melt blended at a temperature in the range of from 150° C. to 250° C. to form the composition.

In some embodiments, the blend further comprises a primary antioxidant, a secondary antioxidant, or a combination thereof. In further embodiments, the primary antioxidant is present in the blend in an amount less than or equal to 1500 ppm and the secondary antioxidant is present in the blend in an amount less than or equal to 1500 ppm, wherein ppm values are based on the total weight of the first PE component and the second PE component.

### First PE Component

The first PE component has a density in the range of from 0.940 g/cm³ to 0.970 g/cm³, a melt index (MI₂) in the range of from 0.10 g/10 min to 1.0 g/10 min, and an ESCR F10 of at least 4 hours to greater than 1000 hours in 100% Igepal. In other embodiments, the first PE component has a density in the range of from 0.945 g/cm³ to 0.958 g/cm³, a melt index (I₂) in the range of from 0.3 g/10 min to 0.6 g/10 min, and an ESCR F50 500 to >1000 hours in 100% Igepal. In some embodiments, the first PE component has an ESCR F10 less than 10 to greater than 1000 hours in 100% Igepal.

In some embodiments, the first PE component has one or more of:
a) a number average molecular weight (Mₙ) in the range of from 8,000 g/mol to 20,000 g/mol or from 11,000 g/mol to 16,000 g/mol;
b) a weight average molecular weight (M_{w}) in the range of from 100,000 g/mol to 200,000 g/mol or from 120,000 g/mol to 190,000 g/mol;
c) a molecular weight distribution (MWD) in the range of from 5 to 20 or from 8 to 16;
d) a high load melt index (HLMI) in the range of from 25 g/10 min to 70 g/10 min or from 30 g/10 min to 65 g/10 min; and
e) a 2% flexural modulus in the range of from 100,000 psi (689 MPa) to 220,000 psi (1,516 MPa), 170,000 psi (1,172 MPa) to 220,000 psi (1,516 MPa) or from 180,000 psi (1,241 MPa) to 210,000 psi (1,778 MPa).

In some embodiments, the first PE component has one or more of (1) a zero shear viscosity (η₀) in the range of from 1.0×10⁶ to 1.6×10⁷, (2) a bulk intrinsic viscosity ([η]) in the range of from 1.50 to 2.1, (3) a long chain branching index (LCBI) in the range of from 0.2 to 2.0, and (4) a swell in the range of 145% to 210%, or in the range of 170% to 210%.

In some embodiments, the HDPE described herein comprise homopolymers and/or copolymers of units derived from ethylene and units derived from one or more of C₃-C₁₂ α-olefins, such as substituted or unsubstituted propylene, butene, pentene, hexene, heptene, octene, nonene, decene, undecene, dodecane, and isomers thereof. For HDPE copolymers, comonomers can be present in amounts up to 10 wt. %, 8 wt. %, 5 wt. %, or 2 wt. %.

In some embodiments, a catalyst based on a Group VIB metal is used to produce the first PE component. In some embodiments the catalyst is a chromium-based catalyst. It is believed that chrome-based resins could be used even though their ESCR is generally lower because of the robustness of the compression molding process in terms of MI. Such HDPE homopolymers and/or copolymers have some long-chain branching and a density in the range of from 0.940 g/cm³ to 0.970 g/cm³.

In some embodiments, a Ziegler-Natta (ZN) catalyst is used to produce the first PE component. Such catalysts are based on a Group IVB transition metal compound and an organoaluminum compound (co-catalyst). Such transition metals, include, but not limited to, Ti, Zr, and Hf. Nonlimiting examples of ZN catalyst systems include TiCl₄+Et₃Al and TiCl₃+AlEt₂Cl. Such HDPE homopolymers and/or copolymers have some long-chain branching and a density in the range of from 0.940 g/cm³ to 0.970 g/cm³.

In some embodiments, the first PE component comprises one or more HDPE homopolymers, one or more HDPE copolymers, or a combination thereof. In some embodiments, the comonomer, if present, is a C4-C8 substituted or unsubstituted alpha-olefin.

In some embodiments, the first PE component comprises one or more HDPE recyclates, one or more virgin HDPEs, or a combination thereof.

In some embodiments, the first PE component comprises one or more HDPE homopolymer recyclates, one or more HDPE copolymer recyclates, or a combination thereof.

### Second PE Blend Component

The second PE component has a density in the range of from 0.910 g/cm³ to 0.970 g/cm³, a melt index (MI₂) in the range of from 5 g/10 min to 35 g/10 min, an ESCR F50 in the range of less than 10 hours to greater than or equal to 1,000 hours in 100% Igepal, and/or an ESCR F10 of less than 10 hours to greater than or equal to 1,000 hours in 100% Igepal. In some embodiments, the second PE component has a density in the range of from 0.915 g/cm³ to 0.958 g/cm³.

In some embodiments, the second PE component has one or more of:
a) a number average molecular weight (Mₙ) in the range of from 9,000 g/mol to 25,000 g/mol or from 10,000 g/mol to 20,000 g/mol;
b) a weight average molecular weight (M_{w}) in the range of from 50,000 g/mol to 100,000 g/mol or from 60,000 g/mol to 90,000 g/mol
c) a molecular weight distribution (MWD) in the range of from 3 to 10 or from 4 to 8;
d) a 2% flexural modulus in the range of 20,000 psi (˜137 MPa) to 220,000 psi (˜1,516 MPa) or from 120,000 psi (827 MPa) to 160,000 psi (1,103 MPa), or from 136,000 psi (938 MPa) to 146,000 psi (1,007 MPa).

In some embodiments, the second PE component has one or more of (1) a zero shear viscosity (η₀) in the range of from 1.0×10³ to 1.0×10⁵, (2) a bulk intrinsic viscosity ([η]) in the range of from 0.8 to 1.3, and (3) a high load melt index (HLMI) in the range of from 100 g/10 min to 1,000 g/10 min. or from 400 g/10 min to 800 g/10 min.

In some embodiments, the second PE component comprises one or more HDPE homopolymers, one or more HDPE copolymers, one or more LDPE copolymers, one or more MDPE copolymers, one or more LLDPE copolymers or a combination thereof. While both the first and second PE component can comprise HDPE, the second PE component is the not same HDPE as the first PE component.

### Compounding Extruder

In some embodiments, the first PE component and the second PE component are fed to an extruder or mixer wherein the blend is subjected to compounding conditions. Compounding conditions are implemented in an extruder or mixer and are tailored for mixtures of specific polyolefins and optionally additives, such as, but not limited to a one or more primary antioxidants, one or more secondary antioxidants, and/or peroxides. Temperature, pressure, and shear force conditions are implemented in the second extruder or mixer sufficient to provide intimate mixing of the first PE component and the second PE component and optionally additives to produce a substantially homogeneous polymer blend of the first PE component and the second PE component. In some embodiments, compounding conditions comprise a temperature in the compounding zone of less than or equal to 300° C., less than or equal to 250° C. or less than or equal to 200° C. In some embodiments, temperatures in the compounding zone can be in the range of from 130° C. to 280° C., from 140° C. to 265° C., or from 150° C. to 250° C.

### Additives

One or more additives can be added to the PE blend. The total amount of additives is less than 5 wt. % based on the total weight of the first PE component and the second PE component.

In some embodiments, primary and/or secondary antioxidants are added to stabilize the reactions for any exposure to oxygen during compounding. In some embodiments, the primary antioxidant is present in the PE blend in an amount less than or equal to 1,900 ppm and the secondary antioxidant is present in the blend in an amount less than or equal to 1,900 ppm, wherein ppm values are based on the total weight of the first PE component and the second PE component.

Primary antioxidants react rapidly with peroxy and alkoxy radicals. Examples of primary antioxidants, sometimes termed “long-term antioxidants,” include phenolic antioxidants and hindered amine antioxidants, such as are disclosed in U.S. Pat. No. 6,392,056, the disclosure of which is incorporated herein in its entirety. Suitable primary antioxidants include, but are not limited to, Irganox™ antioxidants available from BASF, such as Irganox™ 1010, Irganox™ 1076, Irganox™ 1098, Irganox™ 1330, Irganox™ 1425 WL, Irganox™ 3114, Irganox™ 245 and Irganox™ 1135. Examples of suitable antioxidants, including phenolic antioxidants and hindered amine antioxidants, are described in U.S. Pat. No. 7,285,617, the disclosure of which is incorporated herein in its entirety.

Nonlimiting examples of primary antioxidants include 2,6-di-tert.butyl-4-methyl phenol, pentaerythrityl-tetrakis(3-(3′,5′-di-tert.butyl-4-hydroxyphenyl)-propionate, octadecyl 3-(3′,5′-di-tert.butyl-4-hydroxyphenyl)propionate, 1,3,5-tri-methyl-2,4,6-tris-(3,5-di-tert.butyl-4-hydroxyphenyl)benzene, 1,3,5-tris(3′,5′-di-tert.butyl-4′-hydroxybenzyl)-isocyanurate, bis-(3,3-bis-(4-′-hydroxy-3′-tert.butylphenyl)butanic acid)-glycolester, N,N′-hexamethylene bis(3,5-di-tert.butyl-4-hydroxy-hydrocinnamamide, 2,5,7,8-Tetramethyl-2(4′,8′,12′-trimethyltridecyl)chroman-6-ol, 2,2′-ethylidenebis(4,6-di-tert.butylphenol), 1,1,3-tris(2-methyl-4-hydroxy-5-tert.butylphenyl) butane, 1,3,5-tris(4-tert.butyl-3-hydroxy-2,6-dimethylbenzyl)-1,3,5-triazine-2,4-6-(1H,3H,5H)-trione, 3,9-bis(1,1-dimethyl-2-(beta-(3-tert.butyl-4-hydroxy-5-methylphenyl) propionyloxy)ethyl)-2,4,8,10-tetraoxaspiro(5,5) undecane, 1,6-hexanediyl-bis(3,5-bis(1,1-dimethylethyl)-4-hydroxybenzene-propanoate), 2,6-di-tert.butyl-4-nonylphenol, 4,4′-butylidenebis(6-tert.butyl-3-methylphenol), 2,2′-methylene bis(4-methyl-6-tert.butylphenol), and triethyleneglycol-bis-(3-tert.butyl-4-hydroxy-5 methylphenyl) propionate.

Secondary antioxidants, sometimes termed “short-term antioxidants,” can be added to the mixer/extruder at any convenient location. Secondary antioxidants are available commercially, such as the Irgafos™ antioxidants available from BASF, such as Irgafos™ 168, Irgafos™ 126, Irganox™ PS 800 and Irganox™ PS 802.

Examples of secondary antioxidants include, for example, aliphatic thiols and phosphites and phosphonites. Specific examples of secondary antioxidants include distearyl pentaerythritol diphosphite, isodecyl diphenyl phosphite, diisodecyl phenyl phosphite, tris(2,4-di-t-butylphenyl)phosphite, dilauryl-.beta.,.beta.-thiodipropionate, .beta.-naphthyl disulfide, thiol-.beta.-naphthol, 2-mercaptobenzothiazole, benzothiazyl disulfide, phenothiazine, tris(p-nonylphenyl)phosphite, and zinc dimethyldithiocarbamate.

In some embodiments, the PE blend further comprise slip agents and UV stabilizers. Non-limiting exemplary slip agents include amides such as erucamide and other primary fatty amides like oleamide; and further include certain types of secondary (bis) fatty amides. Slip agents, if present, may be greater than 0 to 4000 ppm, 200 to 1000 ppm, or 400 to 2000 ppm, or 600 to 3000 ppm, wherein ppm values are based on the total weight of the first PE component and the second PE component. Non-limiting exemplary UV stabilizers include hindered amine light stabilizers (HALS) such as Chimassorb 944 (BASF) or Tinuvin 119 (BASF). UV Stabilizers, if present, may be greater than 0 to 2000 ppm, 200 to 1000 ppm, or 400 to 1200 ppm, or 600 to 1000 ppm, wherein ppm values are based on the total weight of the first PE component and the second PE component.

### Peroxides

In some embodiments, peroxide-modified resins can be used in the blends. Peroxide treatment conditions are implemented in an extruder. In some embodiments, peroxide treatment conditions mean subjecting a mixture of PE and peroxide to pressure, temperature, and shear force conditions sufficient for the peroxide to react with the PE to result in scission of the polymer chains and/or attachment of some polymer chains along the backbone of other polymer chains to produce long chain branching.

In some embodiments, the amount of a peroxide radical initiator added to the polyethylene composition is in the range of from 0.1 to 100 ppm by weight, alternatively from 0.5 to 100 ppm by weight, of peroxide to polyethylene composition. In some embodiments, the amount of a peroxide radical initiator added to the polyethylene composition is determined via rheology or via film testing. In some embodiments, the amount of radical initiator added to the polyethylene composition is determined via desired change in the rheological polydispersity ER. In some embodiments, the amount of radical initiator added to the polyethylene composition is determined via bubble stability testing.

In some embodiments, the first PE component, the second PE component, and/or the blended composition are treated with a peroxide under temperature, pressure, and shear force conditions in an extruder sufficient to increase the long chain branching and thereby the processability of the first polyethylene component, the second polyethylene component, and/or the composition, as the case may be. The blend composition can also be treated with peroxide during the process of blending the first PE component and the second PE component while under compounding conditions in an extruder or mixer. Improving processability of the first PE component and/or the second PE component prior to blending will improve processability of the composition after blending the components.

In some embodiments, the first PE component, the second PE component, and/or the composition are treated under compounding conditions as disclosed herein. In some embodiments, a temperature in the range of from 150° C. to 250° C. is believed, without wishing to be bound by any particular theory, favors long chain branching over chain scission such that the treated polymer has a higher degree of long chain branching and improved processability through higher melt strength. It is believed that more long chain branching occurs as the temperature is reduced from 250° C. to 150° C.

Nonlimiting examples of suitable radical initiators include one or more of the group consisting of 3-hydroxy-1,1-dimethylbutyl peroxyneodecanoate, a-cumyl peroxyneodecanoate, 2-hydroxy-1,1-dimethylbutyl peroxyneoheptanoate a-cumyl peroxyneoheptanoate, t-amyl peroxyneodecanoate, t-butyl peroxyneodecanoate, di(2-ethylhexyl) peroxydicarbonate, di(n-propyl) peroxydicarbonate, di(sec-butyl) peroxydicarbonate, t-butyl peroxyneoheptanoate, t-amyl peroxypivalate, t-butyl peroxypivalate, diisononanoyl peroxide, didodecanoyl peroxide, 3-hydroxy-1,1-dimethylbutylperoxy-2-ethylhexanoate, didecanoyl peroxide, 2,T-azobis(isobutyronitrile), di(3-carboxypropionyl) peroxide, 2,5-dimethyl-2,5-di(2-ethylhexanoylperoxy)hexane, dibenzoyl peroxide, t-amylperoxy 2-ethylhexanoate, t-butylperoxy 2-ethylhexanoate, t-butyl peroxyisobutyrate, t-butyl peroxy-(cis-3-carboxy)propenoate, 1,1-di(t-amylperoxy)cyclohexane, 1,1-di(t-butylperoxy)-3,3,5-trimethylcyclohexane, 1,1-di(t-butylperoxy) cyclohexane, OO-t-amyl O-(2-ethylhexyl) monoperoxycarbonate, OO-t-butyl O-isopropyl monoperoxycarbonate, OO-t-butyl O-(2-ethylhexyl) monoperoxycarbonate, polyether tetrakis(t-butylperoxycarbonate), 2,5-dimethyl-2,5-di(benzoylperoxy)hexane, t-amyl peroxyacetate, t-amyl peroxybenzoate, t-butyl peroxyisononanoate, t-butyl peroxyacetate, t-butyl peroxybenzoate, di-t-butyl diperoxyphthalate, 2,2-di(t-butylperoxy)butane, 2,2-di(t-amylperoxy)propane, n-butyl 4,4-di(t-butylperoxy)valerate, ethyl 3,3-di(t-amylperoxy)butyrate, ethyl 3,3-di(t-butylperoxy)butyrate, dicumyl peroxide, a,a′-bis(t-butylperoxy)diisopropylbenzene, 2,5-dimethyl-2,5-di(t-butylperoxy) hexane, di(t-amyl) peroxide, t-butyl a-cumyl peroxide, di(t-butyl) peroxide, 2,5-dimethyl-2,5-di(t-butylperoxy)-3-hexyne, dicetil peroxi-dicarbonato, 3,6,9-triethyl-3,6,9-trimethyl-1,4,7-triperoxonane, tert-butylperoxy 2-ethylhexyl carbonate, tert-butyl-peroxide n-butyl fumarate(benzoate), dimyristoyl peroxydiicarbonate, 3,3,5,7,7-pentamethyl-1,2,4-trioxepane, tert-butyl hydroperoxide, bis(4-t-butylcyclohexyl) peroxydicarbonate, and 1,2,4,5,7,8-hexoxonane,3,6,9-trimethyl-3,6,9-tris(ethyl and propyl derivatives).

### Compression Molding

Compression molding is a fast-running plastics conversion process for caps and closures, tubs, containers, and cups providing an efficient processing in terms of short cycle times and low energy consumption. This results in superior performance in terms of throughput and dimensional consistency of final items. With a lower conversion temperature, material is less prone to degradation and warpage.

Polyolefins useful in injection molding processes are typically also useful in compression molding processes, including, but not limited to, production of caps and closures. In some embodiments, polyolefins for use in compression molding have pronounced shear thinning and an over proportional lower flow resistance. Such characteristics help maintain high throughput and superior characteristics on the final item produced, such as, but not limited to ESCR.

Die swell is a common phenomenon in polyolefin extrusion processes in which a melted stream of polymeric material is forced through a die. Relevant processes include, but not limited to, compression molding, and blow molding. Die swell is a phenomenon directly related to entropy and the relaxation of the polymer within the flow stream. A polymer melt flow stream has a constant rate before entering the die, and the polymer chains within the stream occupy a roughly spherical conformation, maximizing entropy. Extrusion through the die causes an increase in polymer flow rate due in part to the reduced cross-sectional area in the die. Polymer chains in the polymer melt flowing through the die start to lose their spherical shape due to the increased flow rate. The polymer chains become more elongated and physical entanglement among polymer chains is reduced to an extent dependent upon the length of time the polymer is in the die. When the polymer stream leaves the die, the remaining physical entanglements cause polymer chains in the die stream to regain a portion of their former shape and spherical volume, in order to return to the roughly spherical conformation that maximizes entropy.

Since polymer chain disentanglement is a kinetic process, a longer die and/or lower flow rate provide more time for disentanglement. Commercial motivations place both a lower limit on polymer flow rate through the die and an upper limit on the time that the polymer can stay in the die. Therefore, there is a need for polymers less prone to a high degree of polymer chain entanglement.

One challenge with some polymers in compression molding caps or closures is inconsistent die swell. The die swell causes problems between the extrudate slicing step and transfer into the mold. The variation in die swell can lead to dimensional and weight differences between closures and potentially lead to downtime. Another challenge with some polymer in compression molding caps or closures is too low of melt strength. After the strand is extruded and prior to it being cut and placed in the mold, the strand melt must support its own weight without collapsing to hold a shape suitable for the mold to cut and capture the strand. Too low of melt strength could lead to the strand collapsing on itself and the cutter missing or miscutting the strand for the mold.

Die swell is related to the elasticity of the polymer due to the possibility of the polymer system to contract and expand. When a system of random coils of entangled polymer chains enters the capillary die under melt conditions, it undergoes a contraction which, after partially relaxing in the capillary, is partially recovered at the outlet, when no longer restrained by the capillary. Swelling upon discharge from the capillary can be very strong for polyolefins, such as, but not limited to, polyethylene and/or polypropylene. The effect of swelling is critical in some polymer processes, such as, but not limited to compression molding. Too much swell can cause processing problems and defects in molded products. ISO 11443 specifies a method for the measurement of die swell through the accessories of capillary rheometers.

Typically, the die swell can also be decreased by adding a polymer less susceptible to such chain entanglement such as, but not limited to, polymers having shorter average chain lengths, resulting in a higher MI₂ and/or MI₂₁. However, this approach offers limited improvement to the overall die swell due to the continued presence of long molecular weight chains in the first polymer component of the blend.

In some embodiments, the presently described blend has a die swell (as measured by ASTM D3835 or ISO 11443) of less than or equal to 205% or less than or equal to 195%, when using compression molding.

The following examples illustrate the invention; however, those skilled in the art will recognize numerous variations within the spirit of the invention and scope of the claims. To facilitate a better understanding of the present invention, the following examples of preferred embodiments are given. In no way should the following examples be read to limit, or to define, the scope of the invention.

### Examples

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Test Methods

Environmental Stress Crack Resistance (ESCR)—The resin environmental stress crack resistance (“ESCR”) was measured in accordance with ASTM-D 1693-21, Method B. In accordance with this test, the susceptibility of a resin to mechanical failure by cracking is measured under constant strain conditions, and in the presence of a crack accelerating agent, such as a soap or other wetting agent. Measurements were carried out on notched specimens, in a 100 percent, by volume, Igepal CO-630 (vendor Rhone-Poulec, NJ) aqueous solution, maintained at 50° C. Ten specimens were evaluated per measurement. The ESCR value of the resin was reported as F10, the calculated 10 percent failure time from the probability graph. The first check of the sample(s) is usually 24 hours after the start of the ESCR test, so any failures that occurred before this time is reported as “less than 24 hours” unless examined earlier at 4 and/or 10 hours after the start of the test.

Densities are determined in accordance with ASTM D-4703 and ASTM D-1505/ISO-1183.

Die swell is determined herein by as measured by ASTM D3835 or ISO 11443.

High load melt index (“12” or “HLMI”) was determined by ASTM D-1238 (190° C./21.6 kg).

Shear rheological measurements are performed in accord with ASTM 4440-95a, which characterize dynamic viscoelastic properties (storage modulus, G′, loss modulus, G″ and complex viscosity, η*, as a function of oscillation frequency, ω). A rotational rheometer (TA Instruments) is used for the rheological measurements. A 25 mm parallel-plate fixture was utilized. Samples were compression molded in disks (˜29 mm diameter and ˜1.3 mm thickness) using a hot press at 190° C. An oscillatory frequency sweep experiment (from 398.1 rad/s to 0.0251 rad/s) was applied at 190° C. The applied strain amplitude is ˜10% and the operating gap is set at 1 mm. Nitrogen flow was applied in the sample chamber to minimize thermal oxidation during the measurement.

Melt elasticity (“ER”) is determined as discussed in R. Shroff and H. Mavridis, “New Measures of Polydispersity from Rheological Data on Polymer Melts,” J. Applied Polymer Science 57 (1995) 1605. See also U.S. Pat. Nos. 7,238,754, 6,171,993 and 5,534,472 (col. 10, lines 20-30), the teachings of which are incorporated herein by reference. Thus, storage modulus (G′) and loss modulus (G″) are measured. The nine lowest frequency points are used (five points per frequency decade) and a linear equation is fitted by least-squares regression to log G′ versus log G″. ER is then calculated from:

$$ER = ( 1 \text{.781} \times {10}^{- 3} ) \times {G}^{′}$$

at a value of G″=5,000 dyn/cm². The same procedure and equation for the ER calculation was used for both linear and long-chain-branched polyolefins.

PDR, or “Overall Polydispersity Measure” is determined as discussed in R. Shroff and H. Mavridis, “New Measures of Polydispersity from Rheological Data on Polymer Melts,” J. Applied Polymer Science 57 (1995) 1605, equation 27 on page 1619, with G*_{ref.1}=1.95*10⁴ dyn/cm² and log₁₀(G*_{ref.3}/G*_{ref.1})=2. The same procedure and equation for the PDR calculation was used for both linear and long-chain-branched polyolefins.

The ratio

$${η}_{0.1}^{*} / {η}_{100}^{*}$$

of complex viscosities,

$${η}_{0.1}^{*} ,$$

at a frequency of 0.1 rad/sec and

$${η}_{100}^{*} ,$$

at a frequency of 100 rad/sec, is used as an additional measure of shear sensitivity and thus rheological breadth, or polydispersity, of the polymer melt.

Melt index (“MI₂”) was determined by ASTM D-1238 (190° C./2.16 kg).

Melt index (“MI₅”) was determined by ASTM D-1238 (190° C./5 kg).

MIRA is the ratio of HLMI to MI₂.

Molecular weight distribution (“MWD”) as well as the molecular weight averages (number-average molecular weight, Mₙ weight-average molecular weight, M_{w}, z-average molecular weight, M_{z}, and z+1 average molecular weight, M_{z+1}) are determined using a high temperature Polymer Char gel permeation chromatography (“GPC”), also referred to as size exclusion chromatography (“SEC”), equipped with a filter-based infrared detector, IR5, a four-capillary differential bridge viscometer, and a Wyatt 18-angle light scattering detector. Mₙ, M_{w}, M_{z},MWD, and short chain branching (SCB) profiles are reported using the IR detector, whereas long chain branch parameter, g′, is determined using the combination of viscometer and IR detector at 145° C. Three Agilent PLgel Olexis GPC columns are used at 145° C. for the polymer fractionation based on the hydrodynamic size in 1,2,4-trichlorobenzene (TCB) with 300 ppm antioxidant butylated hydroxytoluene (BHT) as the mobile phase. 16 mg polymer is weighted in a 10 mL vial and sealed for the GPC measurement. The dissolution process is obtained automatically (in 8 ml TCB) at 160° C. for a period of 1 hour with continuous shaking in an Agilent autosampler. 20 μL Heptane was also injected in the vial during the dissolution process as the flow marker. After the dissolution process, 200 μL solution was injected in the GPC column. The GPC columns are calibrated based on twelve monodispersed polystyrene (PS) standards (provided by PSS) ranging from 578 g/mole to 3,510,000 g/mole. The comonomer compositions (or SCB profiles) are reported based on different calibration profiles obtained using a series of relatively narrow polyethylene (polyethylene with 1-hexene and 1-octene comonomer were provided by Polymer Char, and polyethylene with 1-butene were synthesized internally) with known values of CH₃/1000 total carbon, determined by an established solution NMR technique. GPC one software was used to analyze the data. The long chain branch parameter, g′, is determined by the equation:

$${g}^{′} = [ η ] {/ [ η ]}_{lin}$$

where, [η] is the average intrinsic viscosity of the polymer that is derived by summation of the slices over the GPC profiles as follows:

$$[ η ] = \frac{\sum {{c}_{i} [ η ]}_{i}}{\sum {c}_{i}}$$

where cᵢ is the concentration of a particular slice obtained from IR detector, and [η]ᵢ is the intrinsic viscosity of the slice measured from the viscometer detector. [η]ₗᵢₙ is obtained from the IR detector using Mark-Houwink equation

$$( {[ η ]}_{lin} = \sum {KM}_{i}^{α} )$$

for a linear high density polyethylene, where Mᵢ is the viscosity-average molecular weight for a reference linear polyethylene, K and α are Mark-Houwink constants for a linear polymer, which are K=0.000374, α=0.7265 for a linear polyethylene and K=0.00041, α=0.6570 for a linear polypropylene.

Zero-shear viscosity, η₀, is determined using the Sabia equation fit of dynamic complex viscosity versus radian frequency, as described in of Shroff & Mavridis, (1999) “A Long Chain Branching Index for Essentially Linear Polyethylenes”, Macromolecules, 32, 8454-8464 (with focus on Appendix B), the disclosure of which is fully incorporated by reference herein in its entirety.

### LCBI is Determined Using Equation 13:

$$LCBI = \frac{{η}_{0}^{0.17}}{[ η ]} \frac{1}{4.8} - 1 \qquad ( 13 )$$

Equation 13 and its application are described in of Shroff & Mavridis, (1999) “A Long Chain Branching Index for Essentially Linear Polyethylenes”, Macromolecules, 32, 8454-8464, the disclosure of which is fully incorporated by reference herein in its entirety.

### Samples

Raw materials used in the samples described herein are shown in TABLE 1, below. In more detail, PE 1 is a high density chrome-based copolymer natural resin for conduit applications that require demanding environmental stress crack resistance requirements. PE 1 also offers an excellent balance of stiffness, toughness and ease of processing. PE 2 is an injection molding grade HDPE that finds use in containers, caps, closures, and other housewares. Comparative Examples 1 and 2 were caps from CSD commercially available in the US.

TABLE 1

| Label | Composition | Density (g/cm³) | MI2 (g/10 min) |
|---|---|---|---|
| PE 1 | HDPE Copolymer¹ | 0.948 | 0.34 |
| PE 2 | HDPE¹ | 0.956 | 18 |
| Comparative Example 1 | HDPE | 0.9477² | 0.97 |
| Comparative Example 2 | HDPE | — | 0.74 |

¹Available from LyondellBasell, Houston, TX
²Estimated by NMR

PE 1 has an ESCR F10 of greater than 1,000 hours (100% Igepal) and an ESCR F50 of greater than 1,000 hours (100% Igepal).

TABLE 2 provides formulation for sample blends used in the examples.

TABLE 2

| | | |
|---|---|---|
| Label | PE 1 | PE 2 |

| | | | | |
|---|---|---|---|---|
| Sample 1 | 80 | wt. % | 20 | wt. % |
| Sample 2 | 75 | wt. % | 25 | wt. % |
| Sample 3 | 70 | wt. % | 30 | wt. % |
| Sample 4 | 100 | wt. % | 0 | wt. % |

### Results

TABLE 3 lists the density, I₂, HLMI, MIRA, ESCR F10 (100% Igepal), die swell, and Flexural modulus (2% secant) for the formulations identified in TABLE 2 and the Comparative Examples.

TABLE 3

| | | | | | ESCR F10, | | Flex Mod. |
|---|---|---|---|---|---|---|---|
| | Density, | MI2 | HLMI, | | 100% Igepal, | Die Swell | 2% secant |
| Sample | (g/cm3) | (g/10 min) | (dg/min) | MIRA | (hrs.) | (%) | (PSI) |
| Sample 1 | 0.9499 | 0.74 | 55.2 | 74.4 | 116.7 | 198 | 146288 |
| Sample 2 | 0.9504 | 0.92 | 64.4 | 70.1 | 91.3 | 203 | 148491 |
| Sample 3 | 0.9506 | 1.09 | 73.5 | 67.4 | 55.8 | 200 | 149783 |
| Sample 4 | 0.9490 | 0.35 | 32.9 | 94.3 | >1000 | 192 | 142900 |
| Comparative | 0.9477 | 0.97 | 71.4 | 73.4 | 23.3 | 186.5 | 138955 |
| Example 1 | | | | | | | |
| Comparative | — | 0.74 | 59.2 | 79.9 | — | — | — |
| Example 2 | | | | | | | |

TABLE 4 lists the ER, PDR, ETA0, and ETA*100 for the polymers identified in TABLE 1.

TABLE 4

| | | | ETA0 (from | |
|---|---|---|---|---|
| Samples | ER | PDR | PDR) | ETA*100 |
| Sample 1 | 3.85 | 23.1 | 2.52E+06 | 10800 |
| Sample 2 | 3.79 | 21.2 | 1.86E+06 | 10000 |
| Sample 3 | 3.75 | 20.8 | 1.54E+06 | 8860 |
| Sample 4 | 3.9 | 26.3 | 4.24E+06 | 14200 |
| Comparative | 3.90 | 24.2 | 2.97E+06 | 8390 |
| Example 1 | | | | |
| Comparative | 3.90 | 23.5 | 3.71E+06 | 9160 |
| Example 2 | | | | |

The results surprisingly showed that a conduit grade HDPE with minor amounts of an injection molding grade resin provided similar density and melt indices as the incumbent resins typically used for caps and closures, while improving the ESCR and increasing Flexural Modulus. The present blend would allow for a stronger cap or closure, even when being downgauged, than those currently used in CSD caps. Further, the presently described blends did not experience processing issues. Thus, the presently described blends had higher ESCR, higher stiffness, and similar processability (based on DORS, melt flow, and swell) to the comparative examples and would provide the same or better performance in caps and closures.

For the sake of brevity, only certain ranges are explicitly disclosed herein. However, in addition to recited ranges, any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the processes, machines, film structures, composition of layers, means, methods, and/or steps described in the specification. As one of the ordinary skill in the art will readily appreciate from the disclosure of the present invention, processes, machines, film structures, composition of layers, means, methods, and/or steps, presently existing or later to be developed that perform substantially the same function or achieve substantially the same result as the corresponding embodiments described herein, may be utilized according to the present invention. Accordingly, the appended claims are intended to include within their scope such processes, machines, film structures, composition of layers, means, methods, and/or steps.

What is claimed is:

1. A composition comprising a blend of:
a) from 60 wt. % to 90 wt. % of a first polyethylene (“PE”) component having:
i) a density in the range of from 0.940 g/cm³ to 0.970 g/cm³;
ii) a melt index (MI₂) in the range of from 0.10 g/10 min to 1.0 g/10 min; and
iii) an environmental stress crack resistance (“ESCR”) F10 of at least 4 hours to greater than 1,000 hours in 100% Igepal;
b) from 10 wt. % to 40 wt. % of a second PE component having:
i) a density in the range of from 0.910 g/cm³ to 0.970 g/cm³;
ii) an MI₂ in the range of from 5.0 g/10 min to 35.0 g/10 min; and
iii) an ESCR F10 of less than 10 hours to greater than 1,000 hours in 100% Igepal;
wherein weight percentages are based on the total weight of the first PE component and the second PE component.

2. The composition of claim 1, wherein the second HDPE component is a low density PE (LDPE), a linear low density PE (LLDPE), a medium density PE (MDPE), a high density PE (HDPE) or a combination thereof.

3. The composition of claim 1, wherein the first PE component comprises one or more HDPE homopolymers, one or more HDPE copolymers, or a combination thereof.

4. The composition of claim 1, wherein the second PE component comprises one or more PE homopolymers, one or more PE copolymers, or a combination thereof.

5. The composition of claim 1, the first PE component has one or more of:
a) a number average molecular weight (Mₙ) in the range of from 8,000 g/mol to 20,000 g/mol or from 11,000 g/mol to 16,000 g/mol;
b) a weight average molecular weight (M_{w}) in the range of from 100,000 g/mol to 200,000 g/mol or from 120,000 g/mol to 190,000 g/mol;
c) a molecular weight distribution (MWD) in the range of from 5 to 20 or from 8 to 16;
d) a high load melt index (HLMI) in the range of from 25 g/10 min to 70 g/10 min or from 30 g/10 min to 65 g/10 min;
e) a 2% flexural modulus in the range of from 100,000 psi (689 MPa) to 220,000 psi (1,516 MPa), 170,000 psi (1,172 MPa) to 220,000 psi (1,516 MPa) or from 180,000 psi (1,241 MPa) to 210,000 psi (1,778 MPa);
f) an ESCR F50 in the range of at least 4 hours to greater than or equal to 1,000 hours in 100% Igepal;
g) a zero shear viscosity (η₀) in the range of from 1.0×10⁶ to 1.6×10⁷;
h) a bulk intrinsic viscosity ([η]) in the range of from 1.50 to 2.1;
i) a long chain branching index (LCBI) in the range of from 0.2 to 2.0; or,
j) swell in the range of 145% to 210%, or in the range of 170% to 210%.

6. The composition of claim 1, wherein the second PE component has one or more of:
a) a number average molecular weight (Mₙ) in the range of from 9,000 g/mol to 25,000 g/mol or from 10,000 g/mol to 20,000 g/mol;
b) a weight average molecular weight (M_{w}) in the range of from 50,000 g/mol to 100,000 g/mol or from 60,000 g/mol to 90,000 g/mol;
c) a molecular weight distribution (MWD) in the range of from 3 to 10 or from 4 to 8;
d) a 2% flexural modulus in the range of 20,000 psi (˜137 MPa) to 220,000 psi (˜1,516 MPa), or from 120,000 psi (827 MPa) to 160,000 psi (1,103 MPa), or from 136,000 psi (938 MPa) to 146,000 psi (1,007 MPa);
e) a zero shear viscosity (η₀) in the range of from 1.0×10³ to 1.0×10⁵;
f) a bulk intrinsic viscosity ([η]) in the range of from 0.8 to 1.3; or
g) a high load melt index (HLMI) in the range of from 100 g/10 min to 1,000 g/10 min. or from 400 g/10 min to 800 g/10 min.

7. The composition of claim 1, wherein the composition has:
a) a density in the range of from 0.935 g/cm3 to 0.958 g/cm³;
b) a melt index (MI₂) in the range of from 0.20 g/10 min to 2.0 g/10 min; and
c) an environmental stress crack resistance (“ESCR”) F10 in the range of at least 4 hours and greater than 1,000 hours in 100% Igepal.

8. The composition of claim 1, wherein the composition has one or more of:
a) a number average molecular weight (Mₙ) in the range of from 8,000 g/mol to 20,000 g/mol or in the range of from 10,000 g/mol to 13,000 g/mol;
b) a weight average molecular weight (M_{w}) in the range of from 80,000 g/mol to 200,000 g/mol or from 90,000 g/mol to 160,000 g/mol;
c) a molecular weight distribution (MWD) in the range of from 5 to 20 or from 8 to 15;
d) a high load melt index (HLMI) in the range of from 30 g/10 min to 100 g/10 min or from 45 g/10 min to 80 g/10 min or from 55 g/10 min to 75 g/10 min;
e) a 2% flexural modulus in the range of from 120,000 psi (827 MPa) to 160,000 psi (1,103 MPa) or from 135,000 psi (930 MPa) to 150,000 psi (1,034 MPa);
f) a melt index ratio (MIRA) in the range of from 60 to 90; or
g) a zero shear viscosity (ETA0 or η₀) in the range of from 1.4×10⁶ to 4.0×10⁶.

9. The composition of claim 1, wherein the first PE component and the second PE component are melt blended at a temperature in the range of from 150° C. to 270° C.

10. The composition of claim 1, wherein the blend further comprises a primary antioxidant, a secondary antioxidant, or a combination thereof.

11. The composition of claim 10, wherein primary antioxidant is present in the blend in an amount less than or equal to 1,900 ppm and the secondary antioxidant is present in the blend in an amount less than or equal to 1,900 ppm, wherein ppm values are based on the total weight of the first PE component and the second PE component.

12. The composition of claim 1, wherein the blend further comprises a UV stabilizer, a slip agent or a combination thereof.

13. The composition of claim 12, wherein the slip agent is present in the blend in an amount less than or equal to 4,000 ppm and the UV stabilizer is present in the blend in an amount less than or equal to 2,000 ppm, wherein ppm values are based on the total weight of the first PE component and the second PE component.

14. A cap comprising:
a. a polyethylene (PE) blend comprising:
a) from 60 wt. % to 90 wt. % of a first polyethylene (“PE”) component having:
i) a density in the range of from 0.940 g/cm³ to 0.970 g/cm³;
ii) a melt index (MI₂) in the range of from 0.10 g/10 min to 1.0 g/10 min; and
iii) an environmental stress crack resistance (“ESCR”) F10 in the range of at least 4 hours to greater than 1,000 hours 100% Igepal;
b) from 10 wt. % to 40 wt. % of a second PE component having:
i) a density in the range of from 0.910 g/cm³ to 0.97 g/cm³;
ii) an MI₂ in the range of from 5.0 g/10 min to 35.0 g/10 min; and
iii) an ESCR F10 in the range of less than 24 hours to greater than or equal to 1,000 hours in 100% Igepal;
wherein weight percentages are based on the total weight of the first PE component and the second PE component; and
b. an additive package comprising a primary antioxidant, a secondary antioxidant, a slip agent, a UV stabilizer, or a combination thereof.

15. The cap of claim 14, wherein primary antioxidant is present in the blend in an amount less than or equal to 1,900 ppm, the secondary antioxidant is present in the blend in an amount less than or equal to 1,900 ppm, the slip agent is present in the blend in an amount less than or equal to 3,000 ppm, and the UV stabilizer is present in the blend in an amount less than or equal to 1,500 ppm, wherein ppm values are based on the total weight of the first PE component and the second PE component.

16. The cap of claim 14, wherein the PE blend has:
a) a density in the range of from 0.935 g/cm³ to 0.958 g/cm³;
b) a melt index (MI₂) in the range of from 0.20 g/10 min to 2.0 g/10 min; and
c) an environmental stress crack resistance (“ESCR”) F10 between 24 hours and greater than 1,000 hours in 100% Igepal;
d) a number average molecular weight (Mₙ) in the range of from 8,000 g/mol to 20,000 g/mol or in the range of from 10,000 g/mol to 13,000 g/mol;
e) a weight average molecular weight (M_{w}) in the range of from 80,000 g/mol to 200,000 g/mol or from 90,000 g/mol to 160,000 g/mol;
f) a molecular weight distribution (MWD) in the range of from 5 to 20 or from 8 to 15;
g) a high load melt index (HLMI) in the range of from 30 g/10 min to 100 g/10 min or from 45 g/10 min to 80 g/10 min or from 55 g/10 min to 75 g/10 min;
h) a 2% flexural modulus in the range of from 120,000 psi (827 MPa) to 160,000 psi (1,103 MPa) or from 135,000 psi (930 MPa) to 150,000 psi (1,034 MPa);
i) a melt index ratio (MIRA) in the range of from 60 to 90; or
j) a zero shear viscosity (ETA0 or η₀) in the range of from 1.4×10⁶ to 4.0×10⁶.

17. The cap of claim 14, wherein the first PE component has:
a) a number average molecular weight (Mₙ) in the range of from 8,000 g/mol to 20,000 g/mol or from 11,000 g/mol to 16,000 g/mol;
b) a weight average molecular weight (M_{w}) in the range of from 100,000 g/mol to 200,000 g/mol or from 120,000 g/mol to 190,000 g/mol;
c) a molecular weight distribution (MWD) in the range of from 5 to 20 or from 8 to 16;
d) a high load melt index (HLMI) in the range of from 25 g/10 min to 70 g/10 min or from 30 g/10 min to 65 g/10 min;
e) a 2% flexural modulus in the range of from 100,000 psi (689 MPa) to 220,000 psi (1,516 MPa);
f) an ESCR F50 in the range of at least 4 hours to greater than or equal to 1,000 hours in 100% Igepal;
g) a zero shear viscosity (η₀) in the range of from 1.0×10⁶ to 1.6×10⁷;
h) a bulk intrinsic viscosity ([η]) in the range of from 1.50 to 2.1;
i) a long chain branching index (LCBI) in the range of from 0.2 to 2.0; or,
j) swell in the range of 145% to 210%, or in the range of 170% to 210%.

18. The cap of claim 14, wherein the second PE component has:
a) a number average molecular weight (Mₙ) in the range of from 9,000 g/mol to 25,000 g/mol or from 10,000 g/mol to 20,000 g/mol;
b) a weight average molecular weight (M_{w}) in the range of from 50,000 g/mol to 100,000 g/mol or from 60,000 g/mol to 90,000 g/mol;
c) a molecular weight distribution (MWD) in the range of from 3 to 10 or from 4 to 8;
d) a 2% flexural modulus in the range of 20,000 psi (˜137 MPa) to 220,000 psi (˜1,516 MPa);
e) a zero shear viscosity (η₀) in the range of from 1.0×10³ to 1.0×10⁵;
f) a bulk intrinsic viscosity ([η]) in the range of from 0.8 to 1.3; or
g) a high load melt index (HLMI) in the range of from 100 g/10 min to 1,000 g/10 min. or from 400 g/10 min to 800 g/10 min.

19. The cap of claim 14, wherein the first PE component comprises one or more HDPE homopolymers, one or more PE copolymers, or a combination thereof, the second PE component comprises one or more PE homopolymers, one or more PE copolymers, or a combination thereof.

20. A composition comprising a blend of:
a) from 70 wt. % to 80 wt. % of a first polyethylene (“PE”) component having:
i) a density in the range of from 0.940 g/cm³ to 0.970 g/cm³;
ii) a melt index (MI₂) in the range of from 0.10 g/10 min to 1.0 g/10 min;
iii) an environmental stress crack resistance (“ESCR”) F10 in the range of at least 4 hours to greater than 1,000 hours in 100% Igepal;
iv) a 2% flexural modulus in the range of from 100,000 psi (689 MPa) to 220,000 psi (1,516 MPa);
b) from 20 wt. % to 30 wt. % of a second PE component having:
i) a density in the range of from 0.910 g/cm³ to 0.97 g/cm³;
ii) an MI₂ in the range of from 5.0 g/10 min to 35.0 g/10 min;
iii) an ESCR F10 in the range of less than 24 hours to greater than or equal to 1,000 hours in 100% Igepal; and,
iv) a 2% flexural modulus in the range of 20,000 psi (˜137 MPa) to 220,000 psi (˜1,516 MPa);
wherein weight percentages are based on the total weight of the first PE component and the second PE component,
wherein said composition has:
i) a density in the range of from 0.940 g/cm³ to 0.958 g/cm³;
ii) a melt index (MI2) in the range of from 0.30 g/10 min to 2.0 g/10 min;
iii) an environmental stress crack resistance (“ESCR”) F10 is between 55 and greater than 1,000 hours in 100% Igepal; and
iv) a 2% flexural modulus in the range of 140,000 psi (˜965 MPa) to 150,000 psi (˜1,034 MPa).
